(19) United States
(12) Patent Application Publication
(10) Pub. No.: US 2008/0092831 A1
(43) Pub. Date: Apr. 24, 2008

(54) In-Vehicle Hydrogen Generation Plant

(76) Inventor: Rodolphe J Simon, Dexter, ME (US)

Correspondence Address: BOHAN, MATHERS & ASSOCIATES, LLC, PO BOX 17707, PORTLAND, ME, 04112-8707, US

(21) Appl. No.: 11/875,086

(22) Filed: Oct. 19, 2007

Related U.S. Application Data
(60) Provisional application No. 60/853,107, filed on Oct. 20, 2006.

(51) Int. Cl. F02B 43/10

(52) U.S. Cl. 123/3

(57) ABSTRACT

An in-vehicle hydrogen generation plant generates hydrogen and oxygen on demand for fuel for an internal combustion engine. The hydrogen generation plant includes an electrolysis unit, a water reservoir, a sound-wave generator, and a battery unit. The generation of hydrogen does not require an electrolyte to be added to the water. The battery applies a dc current to the water in the electrolysis unit, while the sound-wave generator applies a pulsed sound wave. The electrolysis and pulsed sound wave together result in rapid breakdown of the molecules into hydrogen and oxygen gases. A secondary power generator that generates electricity from a rotating component of the vehicle drive train may be installed in the motor vehicle, to provide the necessary electrical energy to power the electrolysis unit.

### BACKGROUND INFORMATION

Field of the Invention

The invention relates to the field of water electrolysis to obtain hydrogen and oxygen gases. More particularly, the invention relates to the generation of hydrogen and oxygen for use as fuel in a vehicle with an internal combustion engine.

### BRIEF SUMMARY OF THE INVENTION

The invention is a method of and apparatus for obtaining hydrogen and oxygen from water in an economical and useful manner. The invention further generates hydrogen and oxygen gases from water on demand, in a vehicle, for use as fuel in an internal combustion engine.

An in-vehicle hydrogen generation plant according to the invention comprises an electrolysis unit, a sound-wave generator, and a supply of water. The electrolysis process is enhanced by application of pulsed energy from the sound-wave generator, which weakens the molecular bonds in the water molecules and promotes a breakdown of the molecules into hydrogen and oxygen gases. Normal tap water is used for the electrolysis. No electrolytes, such as a salt or other additive, are added to the water.

Water flows into a reaction chamber of the electrolysis unit. A direct current is applied to the water. This polarizes the water molecules and puts stress on the molecular bonds. At the same time, the sound-wave generator pulses the water at a frequency that causes the molecules to resonate. This puts additional stress on the molecular bonds. Preferably, the sound waves are emitted as square waves, which further stresses the molecules. This stress causes the molecules to distend under the influence of the electrical polar forces. Eventually, the bonds break apart and the hydrogen and oxygen in the water dissociate into hydrogen and oxygen cases, hydrogen collecting at the cathode and oxygen at the anode in the electrolysis unit.

The in-vehicle hydrogen generation plant generates the hydrogen and oxygen on-demand. No storage tanks are needed. Flow lines and the conventional valves and flame arrestors for preventing the gases from flowing back into the generation plant are provided. The gases are fed into the internal combustion engine and are combusted as the sole fuel or in combination with gasoline.

A primary difficulty in the past has been to generate the hydrogen and oxygen gases at an economically feasible cost. Electrolysis requires a significant input of electrical energy and to date, it has been not economically feasible, relative to the cost of gasoline, to use a hydrogen-oxygen generation plant instead of buying gasoline. The use of the sound wave generator, in combination with the electrolysis unit and the application of direct current to the water, enables cost-effective and rapid breakdown of water into hydrogen and oxygen gases.

A secondary power generation system may be installed on the vehicle to provide sufficient electrical power to operate the in-vehicle hydrogen generation plant. Many types of power generation systems that would be suitable for this purpose are known. An example of such a system is an alternator-generator that generates electrical current from a rotational component of the drive train of the motor vehicle. A pulley or gear is mounted on the rotating component of the drive train, such as an axle, wheel, or drive shaft, simply referred to hereinafter as “rotating drive”. The rotational power from the rotating drive is transferred to a second pulley or gear, which is connected to an alternator-generator by a belt, chain, or gear-to-gear connection. The alternator-generator generates voltage that is used directly by the in-vehicle hydrogen generation plant or is stored in a battery. A bank of batteries may be used, with the secondary power generation system constantly charging the batteries when the motor vehicle is in motion.

A second obstacle to the use of hydrogen gas or a hydrogen-oxygen mix of gases as fuel for the internal combustion engine is the difficulty of storing gas on-board the vehicle. The on-demand generation of the hydrogen according to the invention eliminates the need for bulky storage tanks, and eliminates the danger of storing a significant quantity of a highly combustible gas in the vehicle. The in-vehicle hydrogen generation plant of the present invention enables a cost-effective generation of the hydrogen and oxygen gases by providing a battery back-up system in the vehicle that holds a battery ready at all times to provide the energy for the electrolysis and the sound wave generation.

### BRIEF DESCRIPTION OF THE DRAWINGS

The present invention is described with reference to the accompanying drawing.

FIG. 1 is a block diagram of the in-vehicle hydrogen generation plant according to the invention.

FIG. 2 is a schematic diagram of a secondary power generation system that provides electrical current to operate the electrolysis unit in the in-vehicle hydrogen generation plant.

### DETAILED DESCRIPTION OF THE INVENTION

The present invention will now be described more fully in detail with reference to the accompanying drawing, in which a preferred embodiment of the invention is shown. This invention should not, however, be construed as limited to the embodiment set forth herein; rather, it is provided so that this disclosure will be complete and will fully convey the scope of the invention to those skilled in the art.

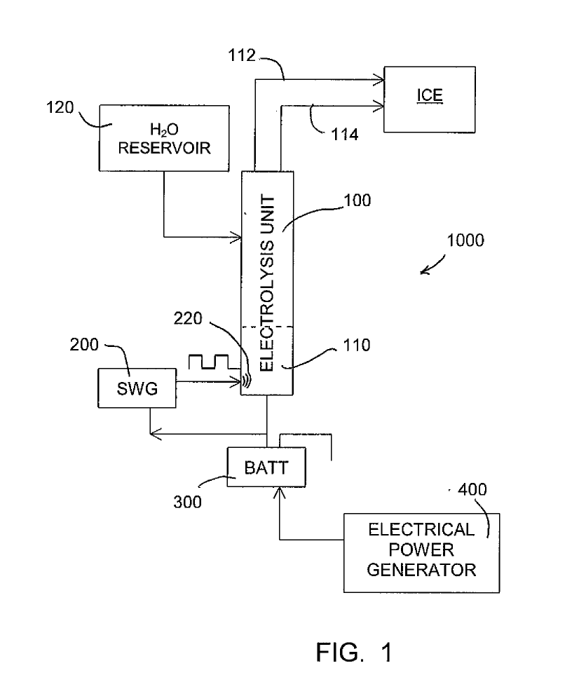

FIG. 1 illustrates an in-vehicle hydrogen generation plant (IVHGP) 1000 according to the invention. The IVHGP 1000 comprises an electrolysis unit 100, a sound-wave generator 200, and an energy source 300. The energy source 300 provides direct current voltage to the sound-wave generator 200 and the electrolysis unit 100. A water reservoir 120 feeds water upon demand to a reaction chamber 110 in the electrolysis unit 100. The sound-wave generator 200 includes a signal emitter 220 that emits sound waves into the reaction chamber 110. Electrical current is applied directly to the water in the reaction chamber 110 to initiate the electrolysis process. At the same time, the sound-wave generator 200 emits pulsed energy into the reaction chamber 110 at a frequency that promotes the breakdown of the water molecules into the component hydrogen and oxygen gases. Preferably, the sound waves are square waves, as these stress the water molecules even more, resulting in even speedier dissolution of the water molecules into oxygen and hydrogen. The gases are collected and fed via separate lines 112, 114 to an internal combustion engine ICE upon demand from the engine.

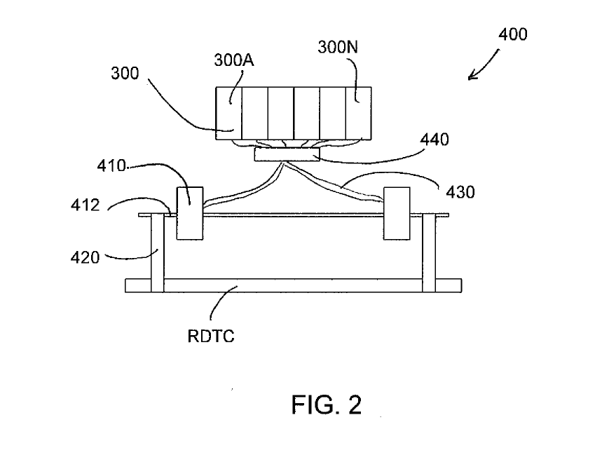

FIG. 2 is a schematic diagram of a secondary power generator 400 that is used to provide the necessary power to operate the IVHGP 1000, and particularly, the electrolysis unit 100. For in-vehicle hydrogen generation, the energy source 300 is typically a DC battery. Preferably, a battery charging and back-up unit, such as the AUXILIARY VEHICLE POWER SUPPLY, disclosed in U.S. Patent Application Publication 2006/0125443 A1, published on Jun. 15, 2006, is used. The subject matter of that patent application is incorporated in its entirely herein by reference. The electrolysis unit 100 typically requires more energy than can be supplied by a single conventional 12 VDC battery for a motor vehicle. The secondary power generator 400 is provided to generate power that is stored in a battery bank. The power source 300 in this embodiment of the electrical power generator 400 is a bank of conventional automotive batteries 300A, 300B, 300C, . . . 300N. An alternator-generato 410 has an input shaft 412 that is coupled via a motion-transfer means 420 with a rotating component of the drive train of the motor vehicle RDTC. In the embodiment shown, the rotating component is a rotating axle and the motion-transfer means 420 is a belt. When the motor vehicle is moving, the axle is, of necessity, rotating. The rotational motion of the axle drives the belt, which in turn drives the input shaft, which in turn generates electricity, which is stored in the power source 300. In order to ensure that all batteries 300A . . . 300N are charged, suitable battery charging and control systen 440, such as the battery charging and back-up unit mentioned above, may be used.

FIG. 2 is a schematic illustration only of the secondary power generator 400. It is understood that the rotating drive train component RDTC may be a component other than the drive axle. Also, the motion-transfer means 420 may be a geared coupler, or chain and sprocket, or other conventional means of transferring rotational motion to the input shaft 412. Two alternator-generators 410 are shown. Here, too, it is understood that one, two, or more alternator-generators 410 may be used to generate electrical energy. The illustration does not show how the secondary power generator 400 is mounted on the motor vehicle. This particular aspect of the secondary power generator 400 is not deemed within the scope of patent protection claimed and is not further described herein.

The in-vehicle hydrogen generation plant 1000 is small enough to fit into a portion of the trunk of a standard automobile.

The in-vehicle hydrogen generation plant 1000 is described above as being the sole source of fuel for the internal combustion engine ICE. The output from the in-vehicle hydrogen generation plant may also be used in a hybrid gasoline-hydrogen or hybrid gasoline-hydrogen-oxygen engine.

It is understood that the embodiments described herein are merely illustrative of the present invention. Variations in the construction of the in-vehicle hydrogen generation plant may be contemplated by one skilled in the art without limiting the intended scope of the invention herein disclosed and as defined by the following claims.

What is claimed is:

1. Hydrogen generation system for providing on-demand hydrogen to an internal combustion engine of a motor vehicle, said hydrogen generation system comprising:
an internal combustion engine adapted for combusting hydrogen as a fuel;
an electrolysis unit for breaking water molecules into hydrogen and oxygen;
conduit lines for feeding hydrogen and oxygen to said internal combustion engine;
a water reservoir system that feeds water into said electrolysis unit; and
a power source for providing electrical energy to said electrolysis unit.

2. The hydrogen generation system of claim 1, further comprising a sound-wave generator that emits sound waves, wherein said electrolysis unit has a reactor chamber and wherein said sound waves are applied to said reactor chamber, said sound waves serving to support the dissolution of water molecules.

3. The hydrogen generation system of claim 1, further comprising a secondary power generator that is adapted to support said power source.

4. The hydrogen generation system of claim 2, said secondary power generator comprising an alternator-generator, and a motion-transfer means, wherein said motion-transfer means couples said alternator-generator with a rotating component of a drive train on said motor vehicle, wherein said alternator-generator converts said rotational motion electrical energy, and wherein said electrical energy is stored in said power source.

5. The hydrogen generation system of claim of claim 4, wherein said power source is a bank of batteries and said secondary power generator charges each of said batteries in said bank of batteries.

6. The hydrogen generation system of claim of claim 5, further comprising a battery charge monitor device that monitors a voltage charge on each battery in said bank of batteries and controls a charging operation from said alternator-generator to said batteries.
